(19) United States
(12) Patent Application Publication
(10) Pub. No.: US 2026/0359449 A1
(43) Pub. Date: Nov. 12, 2026

(54) SYSTEM AND METHOD FOR SOFTWARE ASSESSMENT

(71) Applicant: KhaiCode, Inc., Dover, DE (US)

(72) Inventors: Phuong Dang NGUYEN, Singapore (SG); Thai Quang NGUYEN, Singapore (SG)

(21) Appl. No.: 19/665,857

(22) Filed: May 1, 2026

(30) Foreign Application Priority Data
May 9, 2025 (SG) 10202501208T

(51) Int. Cl. G06F 21/57; G06F 8/61; G06F 8/65; G06F 9/445; G06F 11/3604

(52) U.S. Cl. CPC G06F 21/577; G06F 8/61; G06F 8/65; G06F 9/44505; G06F 11/3604; G06F 2221/033

(57) ABSTRACT

The present invention relates to a system and method for automated security assessment of software across heterogeneous computing environments. The system comprises an orchestration unit configured to emulate operating systems and instruction set architectures to provide live or emulated computing environments where software runs for assessment. One or more analyser units perform static and dynamic analysis to determine vulnerabilities within the software, including vulnerabilities arising from code libraries and dependencies. An exploitation unit generates and deploys exploits targeting the determined vulnerabilities, with parameters adjustable based on the computing environment. A remediation unit generates and validates remediation plans for patching vulnerabilities while ensuring compliance with protocols. An artificial intelligence unit performs pattern learning to assist in vulnerability detection and reduce false positives.

### CROSS-REFERENCE TO RELATED APPLICATIONS

This application claims priority to Singapore Patent Application No. 10202501208T, titled "SYSTEM AND METHOD FOR SOFTWARE ASSESSMENT," filed May 9, 2025, the entire contents of which are incorporated herein by reference.

### FIELD OF THE INVENTION

The invention relates to the technical field of cybersecurity. More specifically, a platform that includes a system and method for software assessment that involves analysing a software to determine its underlying vulnerabilities for their validation and/or remediation.

### BACKGROUND OF THE INVENTION

The advancements in information technology have made computers inseparable from society, and they are now essential infrastructure that ensures connectivity between individuals within the realm of cyberspace. However, this comes with new challenges and risks. In particular, computers require software for their hardware to operate accordingly. In the event that the software of a computer has one or more security flaws, bad actors may exploit the security flaws within the software to compromise the computer. Hence, it is essential for software to be continuously updated for patching out its security flaws. However, depending on the scale and scope of the software, this may prove challenging for software developers. Furthermore, even as the software is updated, bad actors will not be deterred from their attempts in discovering new security flaws. Therefore, means that assist or aid software developers in assessing cybersecurity of a software have become in demand.

An inspection on the existing technologies reveal that there is presently one or more means that provide software developers assistance or aid in assessing cybersecurity of a software. These means include software composition analysis tools, which primarily focuses on analysing open-source software. These means further include static binary analysis tools, which offer static analysis for binaries of a software and vulnerability detection.

There are also disclosed technologies over the prior art that may relate to a system and method for software assessment. Among them include a United States Patent Application US10762214B1, which discloses a system and method for automatically identifying and extracting vulnerability information from binary files. There is included a data store for receiving the binary file and a processor responsible for processing the file. The processor extracts the filename and associated character string information, which is then used to define search parameters based on the filename and a corresponding software version, creating a name-version pair. These search parameters are applied to the extracted information to detect any matches of the name-version pair. If a match is found, the system queries a vulnerability database to identify any vulnerabilities linked to the specific name-version pair.

However, the existing and disclosed technologies that form the prior art remain insufficient in providing a comprehensive software assessment. In particular, computer systems face the technical challenge of executing and assessing software binaries across different operating systems and instruction set architectures without requiring separate dedicated physical or virtual environments for each OS/ISA combination, which consumes significant computational resources and time. Furthermore, computer systems face the technical challenge of validating identified vulnerabilities through proof-of-concept exploit generation that adapts to the specific computing environment in which the software operates, including performing memory offset calculations for different operating system versions. Moreover, computer systems face the technical challenge of generating and validating remediation plans while ensuring the patched software remains compliant with compliance protocols and does not introduce new vulnerabilities or instabilities.

Accordingly, the present disclosure provides a technical solution to these technical problems through: (a) an orchestration unit that emulates operating systems and instruction set architectures to provide computing environments without requiring separate physical or virtual environments for each combination, (b) an exploitation unit that generates exploits with parameters that adapt to the computing environment including memory offset calculations for different operating system versions, and (c) a remediation unit that generates, deploys, and validates remediation plans while mapping remediation tactics to compliance protocols to ensure the patched software remains compliant and does not introduce new vulnerabilities or instabilities.

### SUMMARY OF THE INVENTION

Embodiments of the present disclosure relate to a system and method that may be part of, or is, a cybersecurity platform that provides a supply chain assessment and research framework (SCARF) for at least one software.

More specifically, the system and method of the present disclosure may generally provide any one or a combination of [i] orchestration of at least one live or emulated computing environment for at least one software to run therewithin, [ii] any one or both static analysis and dynamic analysis of at least one software, [iii] detection of one or more vulnerabilities within the software, [iv] generation of one or more exploits for exploiting the detected vulnerabilities within the software and validation of these exploits, and [v] generation of one or more remediation plans for the vulnerabilities within the software and validation of these remediation plans.

Advantageously, the disclosed embodiments enable binaries of code components of a software to be executed across live or emulated computing environments of various systems and architectures, for assessment of the software.

Advantageously as well, the disclosed embodiments further provide integration between computing environment orchestration, exploit generation, and remediation generation. In particular, this enables a software to be executed, analysed, exploited, and remedied, within at least one live or emulated computing environment, thereby streamlining an assessment workflow of a software under assessment.

Advantageously, the disclosed embodiments improve computer security testing technology by enabling cross-platform vulnerability assessment across heterogeneous computing environments. In particular, the orchestration of live or emulated computing environments across various operating systems and instruction set architectures enables comprehensive security assessment that was previously impractical due to the need for separate physical or virtual environments for each OS/ISA combination. Furthermore, the integration of environment emulation with adaptive exploit generation, including memory offset calculations for different operating system versions, reduces the time and computational resources required for comprehensive security assessment while providing more accurate vulnerability detection.

Advantageously as well, the combination of computing environment orchestration, analysis, exploitation, and remediation in an integrated system represents an unconventional technical arrangement that achieves technical results not achievable by the individual components alone. In particular, the integration enables a software to be executed, analysed, exploited, and remedied within at least one live or emulated computing environment in a streamlined workflow, thereby providing a technical solution to the technical problem of assessing software security across heterogeneous computing environments. More specifically, the unconventional arrangement enables: (a) software to be assessed across multiple OS/ISA combinations within a single integrated workflow rather than requiring separate assessment pipelines for each combination, (b) exploits to be automatically adapted to the specific emulated computing environment through memory offset calculations, reducing manual configuration, and (c) remediation plans to be validated against the same exploits within the same emulated environment, creating a closed-loop assessment and remediation cycle that was not previously achievable.

Advantageously as well, the disclosed embodiments further enable assessment of software that may include one or more open source code components, one or more closed source code components (i.e., proprietary code components), or a combination thereof.

Advantageously as well, the disclosed embodiments further enable comprehensive analysis to be performed upon at least one software for its assessment, since the software undergoes both static analysis and dynamic analysis for deeper vulnerability identification within its code components.

Advantageously as well, the present disclosure further provides at least one validation workflow that is capable of auto-adjustment. More specifically, there is provided one or more vulnerability libraries that include multiple versions of exploits. Exploitation of these vulnerabilities is further automated and may be continuously adjusted to cater for various live or emulated computing environment. This allows users to confirm vulnerabilities in the software, and be provided with insights that include a risk and/or a patch priority for the code components within the software.

Advantageously as well, the disclosed embodiments further incorporate and/or deploy one or more machine learning models, which may be involved in performing matching of code components, and performing reachability analysis for the vulnerabilities of the software. This shall enable reduction of false positives within the assessment of the software.

Advantageously as well, the validation engine is further configured to provide and/or assist or aid the user in in-depth research of the software under assessment. In particular, there is further included an interactive artificial intelligence chatbot, which may provide assistance or aid to the user on the decomposed binaries of the software under assessment, for the user to further research and discover vulnerabilities within the software.

Embodiments of the present disclosure intend to provide a system for assessing software or software assessment, comprising at least one processor that operates one or more units, which include units that are configured to analyse at least one software and generate one or more exploits. The software is analysed by the units to determine one or more vulnerabilities therewithin, which include vulnerabilities that arise from any one or both code libraries and code dependencies of the software, for one or more exploits to be generated by at least one unit, which target these vulnerabilities within the software.

Preferably, the units include at least one orchestration unit configured to provide at least one live or emulated computing environment where the software runs therewithin.

Preferably, the units include a first analyser unit configured to decompose the software into one or more code components for their identification, and match each code component with binaries that correspond to known vulnerabilities to provide a risk assessment of the software based on the presence of matches.

Preferably, the units further include a second analyser unit configured to determine one or more attack paths based on one or more code components of the software, determine one or more behavioural patterns of the software as the software runs within the computing environment, and determine at least one correlation between the attack paths and behavioural patterns.

Preferably, the units further include a third analyser unit configured to determine one or more hidden functions within the software that arise as the software runs within the computing environment, and decompile one or more code components that trigger the hidden functions for their analysis.

Preferably, the units further include a vulnerability evaluation unit configured to analyse one or more code components of the software for detecting vulnerabilities and silent fixes within the software, determine one or more attack paths within the software based on the detected vulnerabilities and silent fixes, provide a risk score for each attack path, and sort the attack paths based on their risk scores for their prioritization.

Preferably, the units further include an exploitation unit configured to generate the exploits based on one or more templates, deploy the exploits against the software, wherein the exploits target the vulnerabilities of the software that were determined, and validate successful exploitation of vulnerabilities of the software by the exploits.

Preferably, the units further include an exploitation unit configured to adjust one or more parameters related to at least one exploit for the exploit to adapt to the computing environment in which the software runs therewithin.

Preferably, the units further include a remediation unit configured to generate and deploy at least one remediation plan having one or more tactics for remedying the vulnerabilities of the software, for the software to become a patched software, validate the remediation plan as the patched software is exploited by exploits that target vulnerabilities of the software that were determined, and map the tactics of the remediation plan to one or more compliance protocols to ensure the patched software remains compliant with the compliance protocols.

Preferably, the units further include an artificial intelligence unit configured to perform learning of one or more patterns within one or more code components of the software, and aid at least one user in analysing the software for determining the vulnerabilities within the software.

Embodiments of the present disclosure further intend to provide a method for assessing software or software assessment, comprising the steps of analysing at least one software, by at least one processor that operates one or more units, and generating one or more exploits, at the processor and its operated units. The software is analysed by the units to determine one or more vulnerabilities therewithin, which include vulnerabilities that arise from any one or both code libraries and code dependencies of the software, for one or more exploits to be generated by at least one unit, which target these vulnerabilities within the software.

Preferably, the method further comprising the step of providing at least one live or emulated computing environment where the software runs therewithin, by an orchestration unit.

Preferably, the method further comprises one or more steps performed by a first analyser unit, which include decomposing the software into one or more code components for their identification, and matching each code component with binaries that correspond to known vulnerabilities to provide a risk assessment of the software based on the presence of matches, by the first analyser unit.

Preferably, the method further comprises one or more steps performed by a second analyser unit, which include determining one or more attack paths based on one or more code components of the software, determining one or more behavioural patterns of the software as the software runs within the computing environment, and determining at least one correlation between the attack paths and behavioural patterns.

Preferably, the method further comprises one or more steps performed by a third analyser unit, which include determining one or more hidden functions within the software that arise as the software runs within the computing environment, and decompiling one or more code components that trigger the hidden functions for their analysis.

Preferably, the method further comprises one or more steps performed by a vulnerability evaluation unit, which include analysing one or more code components of the software for detecting vulnerabilities and silent fixes within the software, determining one or more attack paths within the software based on the detected vulnerabilities and silent fixes, providing a risk score for each attack path, and sorting the attack paths based on their risk scores for their prioritization.

Preferably, the method further comprises one or more steps performed by an exploitation unit, which include generating the exploits based on one or more templates, deploying the exploits against the software, wherein the exploits target the vulnerabilities of the software that were determined, and validating successful exploitation of vulnerabilities of the software by the exploits.

Preferably, the method further comprises the step of adjusting one or more parameters related to at least one exploit for the exploit to adapt to the computing environment in which the software runs therewithin, by the exploitation unit.

Preferably, the method further comprises one or more steps performed by a remediation unit, which include generating and deploying at least one remediation plan having one or more tactics for remedying the vulnerabilities of the software, for the software to become a patched software, validating the remediation plan as the patched software is exploited by exploits that target vulnerabilities of the software that were determined, and mapping the tactics of the remediation plan to one or more compliance protocols to ensure the patched software remains compliant with the compliance protocols.

Preferably, the method further comprises one or more steps performed by an artificial intelligence unit, which include performing learning of one or more patterns within one or more code components of the software, and aiding at least one user in analysing the software for determining the vulnerabilities within the software.

One skilled in the art will readily appreciate that the disclosed embodiments are well adapted to carry out the objects and obtain the ends and advantages mentioned, as well as those inherent therein. The embodiments described herein are not intended as limitations on the scope of the invention.

### BRIEF DESCRIPTION OF FIGURES

To facilitate an understanding of the invention, there is illustrated in the accompanying drawings the preferred embodiments from an inspection of which when considered in connection with the following description, the invention, its construction and operation and many of its advantages would be readily understood and appreciated.

FIG. 1 illustrates a schematic diagram of a system for software assessment, showing the first device comprising units including an orchestration unit, analyser units, an artificial intelligence unit, a vulnerability evaluation unit, an exploitation unit, and a remediation unit, in communication with a second device and a database, in accordance with an embodiment of the present disclosure.

FIG. 2 illustrates a schematic diagram of an orchestration unit within the system, showing an environment creation module, an emulation engine module, and a deployment module, in accordance with an embodiment of the present disclosure.

FIG. 3 illustrates a flowchart depicting steps performed by modules of the orchestration unit for orchestrating a computing environment, including software selection, configuration, operating system and architecture selection, emulation, deployment, software installation, and validation, in accordance with an embodiment of the present disclosure.

FIG. 4 illustrates a schematic diagram of a first analyser unit within the system, showing modules including an enumeration module, a decomposition module, a pattern matching module, a signature analysis module, a string extraction module, a component identification module, a version detection module, a vulnerability processing module, and a first report generation module, in accordance with an embodiment of the present disclosure.

FIG. 5 illustrates a flowchart depicting steps performed by modules of the first analyser unit for performing static analysis on software, including enumeration, decomposition, pattern matching, signature analysis, string extraction, component identification, version detection, vulnerability processing, and report generation, in accordance with an embodiment of the present disclosure.

FIG. 6 illustrates a schematic diagram of a second analyser unit within the system, showing modules including a process monitor module, a component analysis module, a pattern recognition module, an attack path analysis module, a behaviour tracking module, a first pattern analysis module, a vulnerability detection module, a correlation module, and a second report generation module, in accordance with an embodiment of the present disclosure.

FIG. 7 illustrates a flowchart depicting steps performed by modules of the second analyser unit for performing dynamic analysis on software, including runtime monitoring, component analysis, pattern recognition, attack path analysis, behaviour tracking, vulnerability detection, and correlation determination, in accordance with an embodiment of the present disclosure.

FIG. 8 illustrates a schematic diagram of a third analyser unit within the system, showing modules including a first code analysis module, a second pattern analysis module, a hidden function detection module, a reachability analysis module, a decompilation module, a second code analysis module, an interactive analysis module, a vulnerability assessment module, a function documentation module, and a third report generation module, in accordance with an embodiment of the present disclosure.

FIG. 9 illustrates a flowchart depicting steps performed by modules of the third analyser unit for performing dynamic analysis including hidden function detection, reachability analysis, decompilation, and vulnerability assessment, in accordance with an embodiment of the present disclosure.

FIG. 10 illustrates a schematic diagram of an artificial intelligence unit within the system, showing modules including an analysis engine module, a pattern collection module, a learning engine module, a pattern verification module, and a database update module, in accordance with an embodiment of the present disclosure.

FIG. 11 illustrates a flowchart depicting steps performed by modules of the artificial intelligence unit for learning patterns, including executing analysis, collecting patterns, performing learning, verifying patterns, and updating a database, in accordance with an embodiment of the present disclosure.

FIG. 12 illustrates a schematic diagram of a vulnerability evaluation unit within the system, showing modules including an attack surface mapping module, a scanning module, a code and configuration analysis module, a code library analysis module, a vulnerability detection module, a silent fix detection module, an exploitability analysis module, an attack path mapping module, a risk calculation module, a risk prioritization module, and a remediation recommendation module, in accordance with an embodiment of the present disclosure.

FIG. 13 illustrates a flowchart depicting steps performed by modules of the vulnerability evaluation unit for determining and evaluating vulnerabilities, including attack surface mapping, scanning, code analysis, vulnerability detection, silent fix detection, exploitability analysis, attack path mapping, risk calculation, risk prioritization, and remediation recommendation, in accordance with an embodiment of the present disclosure.

FIG. 14 illustrates a schematic diagram of an exploitation unit within the system, showing modules including a vulnerability input module, an exploit selection module, an exploit payload generation module, an exploit deployment module, an exploit adaptation module, an exploit validation module, and a fourth report generation module, in accordance with an embodiment of the present disclosure.

FIG. 15 illustrates a flowchart depicting steps performed by modules of the exploitation unit for generating and validating exploits, including vulnerability input, exploit selection, payload generation, computing environment setup, exploit deployment, exploit adaptation, and exploit validation, in accordance with an embodiment of the present disclosure.

FIG. 16 illustrates a schematic diagram of a remediation unit within the system, showing modules including a remediation planning module, a remediation assistant module, a remediation deployment module, a remediation validation module, a remediation fix module, a compliance mapping module, and a fifth report generation module, in accordance with an embodiment of the present disclosure.

FIG. 17 illustrates a flowchart depicting steps performed by modules of the remediation unit for remediating vulnerabilities, including report retrieval, remediation strategy generation, remediation assistance, remediation plan proposal, deployment, validation, compliance mapping, and fix determination, in accordance with an embodiment of the present disclosure.

### DETAILED DESCRIPTION OF THE INVENTION

The present disclosure relates to a system and method for software assessment. To reiterate, embodiments described in the present disclosure may be part of, or is, a cybersecurity system that provides assessment of at least one software.

From hereon as well, it will be understood that the software that undergoes assessment may be a computer-executable entity that may be operated by at least one processor. The software may comprise one or more lines of code that define one or more sets of code components, which are computer-executable instructions. The computer-executable instructions of the software may be of one or more levels of abstraction. More specifically, the computer-executable instructions may be represented as codes in the form of one or more high-level programming languages (e.g., Python, JavaScript, etc.), codes in the form of one or more mid-level programming languages (e.g., C, C++, etc.), codes in the form of one or more low-level programming languages (e.g., assembly, binaries, machine code, etc.), or a combination thereof.

For example, the software that undergoes assessment may be one that is written in at least one low-level programming language that may have a low level of abstraction for direct control of hardware. Such software may, by way of example, include firmware architectures such as Basic Input/Output System (BIOS), Unified Extensible Firmware Interface (UEFI), or the like.

In another example, the software that undergoes assessment may be one that is written in any one or a combination of programming languages of various levels that may have a level of abstraction suitable for managing resources between end-user software and hardware. Such software may, by way of example, include operating systems such as the Linux operating system, the Windows operating system, the Unix operating system, Unix-like operating systems such as MacOS, the QNX operating system, or the like. Such software may, by way of example, further include drivers that may be configured to control one or more hardware devices.

In yet another example, the software that is to undergo assessment may be one that is written in at least one high-level programming language that may have a high level of abstraction for performing specialized tasks for a user. Such software may, by way of example, include software that runs on an operating system, or the like.

It is to be noted that in certain embodiments, the software that is to undergo assessment may be in the form of one or more files, which each file having one or more sets of code components compiled therewithin. The files may each be linked with each other to form libraries and/or dependencies. The files may each have different file formats, or file formats of the same.

It is to be noted that one or more steps may be described for the methods involved within the present disclosure. It is to be noted that the steps described in this detailed description are to be interpreted as non-limiting, and minor modifications to the steps (e.g. additions, omissions, repetitions, or swaps) are permissible by a skilled person without substantial deviation from as described.

Embodiments of the present disclosure will now be described in greater detail, by way of example, with reference to the figures. For ease of reference, common reference numerals or series of numerals will be used throughout the figures when referring to the same or similar features common to the figures.

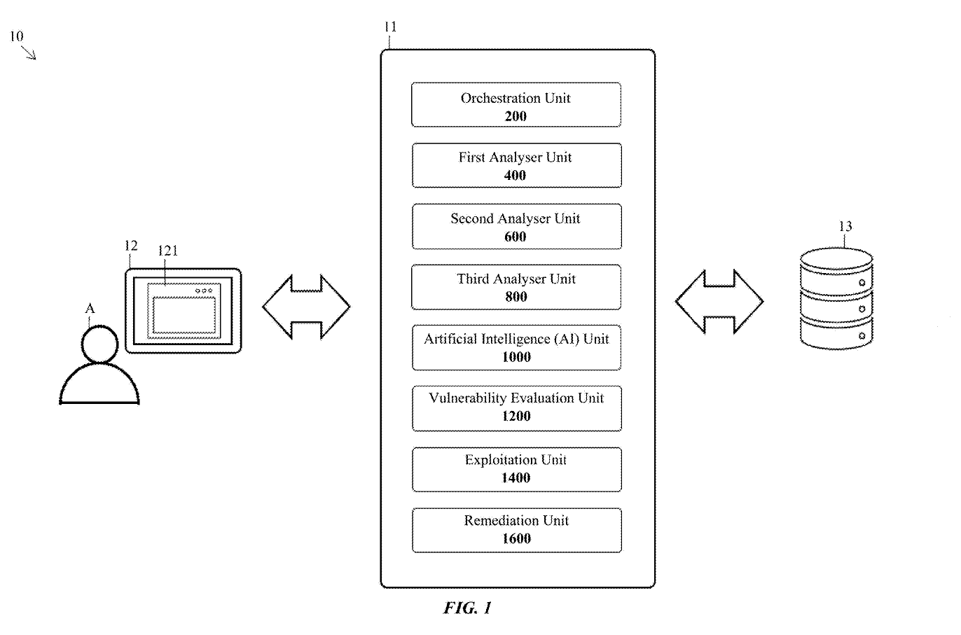

FIG. 1 illustrates a schematic diagram of the system 10 for software assessment, in accordance with an embodiment of the present disclosure. As shown, the system 10 may generally comprise one or more first devices 11, one or more second devices 12, and one or more data storage media 13.

With reference to FIG. 1, the first device 11 may comprise at least one processor that operates one or more units. These units may include an orchestration unit 200, a first analyser unit 400, a second analyser unit 600, a third analyser unit 800, an artificial intelligence unit (AI) unit 1000, a vulnerability evaluation unit 1200, an exploitation unit 1400, and a remediation unit 1600. The units may be implemented as instructions stored on a non-transitory computer-readable medium that, when executed by the processor, cause the processor to perform the functions of the units. It is to be noted that first device 11 may be to be part of, or is, a cloud computing infrastructure, a local computing infrastructure, or a combination thereof.

Whilst not shown in FIG. 1 it is to be noted that the first device 11 may be in the form of a computer, acting as a server, which comprises at least one processor. In one embodiment, the units of the first device 11 may be hardware components, with each unit having at least one corresponding processor, in which each unit is configured to perform a designated function. In one alternative embodiment, the units of the first device 11 may be software components that are operated by the processor of the first device 11. In yet another alternative embodiment, the units of the first device 11 may be a mixture of hardware components and software components that are operated by one or more processors. It is to be noted that the processors, by way of example, may include at least one conventional processor, at least one application specific integrated circuit (ASIC), at least one graphics processing unit (GPU), at least one tensor processing unit (TPU), or the like or a combination thereof. In certain embodiments, the units may be implemented as instructions stored on one or more non-transitory computer-readable media. The non-transitory computer-readable media may include, by way of example, read-only memory (ROM), random-access memory (RAM), flash memory, hard disk drives, solid-state drives, optical discs, or the like, or a combination thereof. When executed by the processor, the instructions stored on the non-transitory computer-readable media may cause the processor to perform the functions of the units as described herein.

It is to be noted that units of the first device 11 may be implemented in a localized manner as shown in FIG. 1, wherein the units are part of the first device 11 or a local computing infrastructure. More specifically, the units may be deployed on at least one computer that may be owned by the user A or a group of users.

It is to be noted that the units, which have been presented to be part of the first device 11, may not be part of the first device 11, in which they may be operated by at least one processor of a different device. More specifically, in certain embodiments, each unit may be deployed across a plurality of remote computers on a cloud computing infrastructure for sharing of computing resources to provide a scalable and automated analysis of the software 121.

Furthermore, in certain embodiments, one or more units may be deployed within a cloud computing infrastructure and one or more units may be deployed within a local computing infrastructure. It is to be noted that the first device 11 may further comprise one or more non-transitory computer-readable media having instructions stored thereon that, when executed by the at least one processor, cause the processor to operate the units described herein. The non-transitory computer-readable media may include, but shall not be limited to, magnetic media such as hard disks, floppy disks, and magnetic tape; optical media such as compact discs (CDs) and digital versatile discs (DVDs); magneto-optical media; solid-state storage devices such as solid-state drives (SSDs), flash memory, and read-only memory (ROM); random access memory (RAM); or any other media capable of storing instructions for execution by the processor. The instructions may be in the form of software, firmware, or any combination thereof.

With reference to FIG. 1, the second device 12 is one that enables at least one user A to interact therewith. The second device 12 may be configured to communicate with the first device 11 for data content to be exchanged between them. The user A may be, by way of example, a software developer, or the like. The second device 12 may be, by way of example, a display device that is configured to display a user interface (UI) for the user A to interact therewith. The user A may interact with the second device 12 for selecting a software 121 for its assessment. With that, the second device 12 may then send the selected software 121 to the first device 11, for the units of the first device 11 to perform assessment upon the software 121. The user A may also interact with the second device 12 for viewing and/or configuring the assessment that is performed upon the software 121 by the units of the first device 11. It is to be noted that the second device 12 may further comprise one or more non-transitory computer-readable media having instructions stored thereon that, when executed by at least one processor of the second device 12, cause the processor to perform operations including displaying a user interface for the user A to interact therewith, enabling selection of the software 121 for assessment, transmitting the selected software 121 to the first device 11, and displaying assessment results received from the first device 11. The non-transitory computer-readable media may include, but shall not be limited to, magnetic media such as hard disks, floppy disks, and magnetic tape; optical media such as compact discs (CDs) and digital versatile discs (DVDs); magneto-optical media; solid-state storage devices such as solid-state drives (SSDs), flash memory, and read-only memory (ROM); random access memory (RAM); or any other media capable of storing instructions for execution by the processor.

With reference to FIG. 1, the data storage medium 13 is a device that is configured to store information therewithin in the form of data content. In particular, the data content stored in the data storage medium 13 may include, but shall not be limited to, a library of code components, assessment results of at least one assessed software in the form of one or more reports, weights and biases for one or more machine learning models, or the like. The data storage medium 13 may be to be part of, or is, a cloud computing infrastructure, a local computing infrastructure, or a combination thereof. Furthermore, the data storage medium 13 may be configured to be in communication with the first device 11 for data content to be exchanged between the units of the first device 11 and the data storage medium 13. The data storage medium 13 includes either one or a combination of volatile memory or non-volatile memory for storing data in a permanent, semi-permanent, or non-permanent manner. From hereon, it is to be noted that data storage medium 13 may also be referred to as database 13.

Whilst not shown in FIG. 1, the first device 11 may be configured to perform communications via at least one network, at least one point-to-point connection, or a combination thereof. This shall enable the first device 11 to exchange data content with the second device 12 and the database 13. Furthermore, the first device 11 may be configured to be connected to the internet for it to have access to other devices connected to the internet. This may enable the first device 11 to look up information available on the internet, as well as download data from other devices over the internet to facilitate assessment of the software 121. For example, the first device 11 may connect with and/or access one or more code repositories available on the internet, for referencing the said code repository, and/or for downloading the said code repository onto the first device 11.

With reference to FIG. 1, it is to be noted that the units of the first device 11 may allow at least one software 121 selected by the user A to undergo at least one form of assessment for determining its underlying vulnerabilities through one or more analytical approaches. The assessment may further cover supply chain(s) of the code components within the software (e.g., code libraries, code dependencies, etc.). More specifically, the units of the first device 11 may define a supply chain assessment and research framework (SCARF). More specifically, it is to be noted that the software 121 may include one or more open source code components, one or more closed source code components (i.e. proprietary code components), or a combination thereof.

In particular, the orchestration unit 200 is configured to provide or orchestrate at least one live or emulated computing environment for at least one software 121 selected for assessment to run therewithin. In particular, the orchestration unit 200 orchestrates one or more computing environments that may be of one or a combination of abstraction levels. By way of example, the orchestration unit 200 may orchestrate one or more operating systems, which may include, but shall not be limited to, the Windows operating system, the Unix operating system, Unix-like operating systems such as MacOS, the QNX operating system, or the like. By way of example, the orchestration unit 200 may orchestrate, or further orchestrate, one or more instruction set architectures (ISAs), which may include, but shall not be limited to, x86 (16-bit extension, 32-bit extension, 64-bit extension, etc.), ARM (64-bit extension, etc.), MIPS, PowerPC, RISC–V, Atmel AVR, or the like. By way of example, the orchestration unit 200 may orchestrate or further orchestrate one or more firmware architectures, which may include, but shall not be limited to, a Unified Extensible Firmware Interface (UEFI), a Basic Input/Output System (BIOS), or the like. In certain embodiments, the orchestration unit 200 may orchestrate the computing environment over one or more virtual machines, which may or may not be part of the first device 11.

In particular, the first analyser unit 400, the second analyser unit 600, and the third analyser unit 800 may be configured to perform any one or both static analysis and dynamic analysis of at least one software 121 selected for assessment.

In particular, the vulnerability evaluation unit 1200 is configured to enable discovery of one or more vulnerabilities within at least one software 121 selected for assessment.

The vulnerability evaluation unit 1200 may be configured to identify one or more potential attack surfaces, which are attack vectors of the software 121. More specifically, the vulnerability evaluation unit 1200 may evaluate a supply chain of the code components within the software 121, interactions of code components within the software 121, and interactions of the code components of the software 121 with the computing environment, to determine potential attack vectors within its code components, their libraries, and their dependencies.

The vulnerability evaluation unit 1200 may be configured, or further configured, to consider the analysis results from the analyser units 400, 600, 800 and perform scanning within bytecode of the software 121 for detecting weaknesses, coding flaws, misconfigurations, and potential security issues throughout the application stack and/or software stack relevant to the software 121.

The vulnerability evaluation unit 1200 may be configured, or further configured, to analyse potential attack paths of the software 121 by mapping known vulnerabilities within libraries of a code component supply chain to vulnerabilities of the software 121.

The vulnerability evaluation unit 1200 may be configured, or further configured, to provide an evaluation of the exploitability of the software 121 based on any one or a combination of known public exploits against its vulnerabilities, complexity of the exploits, required access for the exploits, potential impact of the exploits on the software 121, and computing environmental conditions required for the exploits, to determine realistic exploitation potential within the software 121 for prioritization of relevant remediation efforts on the software 121.

The vulnerability evaluation unit 1200 may be configured, or further configured, to provide risk prioritization by calculating risk scores based on one or more factors, which may include, by way of example, Common Vulnerability Scoring System (CVSS) metrics, exploit availability, and contextual information within the computing environment, to provide actionable prioritization for remediation efforts.

The vulnerability evaluation unit 1200 may be configured, or further configured, to determine undocumented fixes (i.e., "silent fixes") that may have been made upon the software 121. In particular, the vulnerability evaluation unit 1200 may automatically detect silent fixes particularly in or within open-source code components by analysing code changes within its corresponding code repositories. The vulnerability evaluation unit 1200 may also determine behavioral differences and/or version differences between the code components and their corresponding code repositories.

In particular, the exploitation unit 1400 may be configured to perform generation and deployment of exploits within the live or emulated computing environment in an automated manner, for exploiting vulnerabilities within the software 121 selected for assessment that may be operating within the live or emulated computing environment. The exploits may be generated by use of artificial intelligence under assistance of the artificial intelligence unit 1000. The exploitation unit 1400 may further validate these generated exploits.

The exploitation unit 1400 may be configured, or further configured, to provide a user with a set of pre-developed and/or proprietary exploits in the form of one or more reusable templates. In particular, these templates each include vulnerable libraries of various version, so that the exploitation unit 1400 can provide a Proof-of-Concept of a generated exploit for validation of the identified vulnerabilities within the software 121.

The exploitation unit 1400 may be configured, or further configured, to enable generated exploits to adapt to at least one operating system and at least one firmware architecture of the computing environment. In particular, publicly available exploits may be modified for them to adapt to a specific computing environment and/or be part of the templates.

The exploitation unit 1400 may be configured, or further configured, to perform automated exploit adjustment. By way of example, the exploitation unit 1400 may provide memory offset calculations for the generated exploit to adapt to different operating systems of different versions, thereby allowing seamless exploit execution across emulated computing environments.

The exploitation unit 1400 may be configured, or further configured, to create and configure one or more computing environments based on the architecture, operating system, and vulnerability payload options. This may reduce the time and effort required to set up an exploitation environment.

In particular, the remediation unit 1600 may be configured to perform generation and deployment of one or more remediation plans within the live or emulated computing environment, for patching the vulnerabilities within the software 121 selected for assessment, which may be operating within the computing environment. The software remediation unit 1600 may be further configured to a degree of context awareness and validate the remediation plans for the software 121.

The remediation unit 1600 may be configured, or further configured, to provide generation of customized remediation plans for a software 121. The generation of these customized remediation plans may be based on a live or emulated computing environment in which the software 121 runs thereon, configuration of the software 121, security controls of the software 121, so that these customized remediation strategies align with specific deployment contexts and organizational requirements.

The remediation unit 1600 may be configured, or further configured, to validate patches implemented through the generated remediation plans through automated testing. This ensures that patches for the software 121 are effective and do not introduce new vulnerabilities into the software 121 nor enable the software 121 to cause instabilities in the live or emulated computing environment.

The remediation unit 1600 may be configured, or further configured, to provide some form of assistance or aid as it may be interfaced with the artificial intelligence unit 1000. By way of example, the assistance or aid may be in the form of an interactive chatbot that offers real-time guidance, configuration recommendations, and/or step-by-step remediation instructions for a software 121 based on one or more computing environment in which the software 121 runs thereon.

The remediation unit 1600 may be configured, or further configured, to map remediation plans to either one or both regulatory requirements and security standards, so that comprehensive audit trails and compliance documentation are maintained.

The remediation unit 1600 may be configured, or further configured, to generate purpose-specific reports and dashboards tailored to different audiences, which may include executive summaries, detailed technical documentation, compliance evidence, or the like.

In particular, the artificial intelligence unit 1000 may be configured to provide automated assistance or aid for assessing the software 121 selected for assessment, which may be operating within the computing environment. In particular, the artificial intelligence unit 1000 may facilitate deployment of one or more machine learning models that may provide any one or both (i) automated identification of patterns within code components the software 121, and (ii) interactive assistance or aid for the user A to identify vulnerabilities within the software 121, which may be in the form of a chatbot that provides one or more responses based on prompts provided by the user A.

The artificial intelligence unit 1000 may be configured, or further configured, to be interfaced with any one or a combination of the analyser units 400, 600, 800 to perform static analysis and/or dynamic analysis. The artificial intelligence unit 1000 may assist or aid in the static analysis by identifying known vulnerabilities within the code components of the software 121. The artificial intelligence unit 1000 may also assist or aid in performing dynamic analysis by performing code matching, pattern recognition, and attack path analysis, to reduce false positives and enhance the accuracy of detected vulnerabilities within the software 121. Furthermore, during dynamic analysis, the artificial intelligence unit 1000 may further assist or aid in monitoring and analysing runtime behaviour of the software 121 to discover vulnerabilities that only manifest during execution of the software 121.

The artificial intelligence unit 1000 may be configured, or further configured, to enable automated discovery of hidden functions within a software 121 through reachability analysis.

The artificial intelligence unit 1000 may be configured, or further configured, to allow the user to perform advance vulnerability research. In particular, the artificial intelligence unit 1000 may provide an interactive chatbot that may assist or aid the user in studying code components, their libraries, and their dependencies, within the software 121 to identify potential vulnerabilities.

The artificial intelligence unit 1000 may be configured, or further configured, to enable automated generation of exploits that target vulnerabilities within the software 121 based on one or more computing environments.

The artificial intelligence unit 1000 may be configured, or further configured, to perform a form of self-supervised learning for it or its machine learning models to self-improve in a continuous manner. More specifically, the artificial intelligence unit 1000 may collect and verify one or more patterns derived from the static analysis and/or the dynamic analysis and fine-tune one or more machine learning models to enhance their detection accuracy of vulnerabilities within the software 121.

With this, it is to be stated that the present disclosure further provides a method for software assessment, which may generally involve one or more steps.

The first step for the method of software assessment may involve at least one user A interacting with the second device 12, for selecting at least one software 121 for assessment. As previously described, the software 121 may be, by way of example, in the form of one or more binaries or an executable file, which may include any one or a combination of both open-source code components and closed-sourced or proprietary code components. With that, the software 121 may be provided to the first device 11 of it to undergo assessment.

The second step for the method of software assessment may involve at least one user A interacting with the second device 12 for prompting the orchestration unit 200 to provide or orchestrate at least one live or emulated computing that is suitable for the software 121 to run thereon. The live or emulated computing environment may be one that is dynamic and/or controllable, in which the software 121 is to be assessed as the software 121 runs thereon. The live or emulated computing environment may have the necessary operating system, instruction set architecture, and/or firmware architecture, to allow the software 121 to be executed thereon for its assessment. In certain embodiments, orchestration unit 200 may automatically analyse the software 121 and determine a suitable computing environment for it to be executed and run therewithin.

The third step for the method of software assessment may involve one or more analyser units of the first device 11 performing analysis upon the software 121. More specifically, either one or a combination of the first analyser unit 400, the second analyser unit 600, and the third analyser unit 800, may perform static analysis and/or dynamic analysis upon the software 121. By way of example, these analyser units may perform static analysis to detect the libraries and/or dependencies of the code components within the software 121. By way of example, these analyser units may perform, or further perform, dynamic analysis upon the software 121 that may be running on the computing environment to identify components, vulnerabilities, and behaviours that occur during runtime of the software.

It is to be noted that any one or a combination of the analyser units of the first device 11 may interface and/or communicate with the artificial intelligence unit 1000. The artificial intelligence unit 1000 may be involved in operating one or more machine learning models that act as engines for performing pattern recognition of code components within the software, and/or matching of code components with a reference.

The fourth step for the method of software assessment may involve the vulnerability evaluation unit 1200 identifying vulnerabilities within the software 121. This may be done based on the results of the analyser units. In particular, the identified code components may be cross-referenced with one or more knowledge bases that have vulnerability documentations. These knowledge bases may be available within the database 13 (i.e. internal databases) and/or available on the internet (i.e. external databases). The vulnerability documentations may be used for identifying vulnerabilities within the software 121. The vulnerability evaluation unit 1200 may be further configured to provide an integrity level for the software 121, possible protection mechanisms for the software 121, and exploit applicability of the vulnerabilities of the software 121.

The fifth step for the method of software assessment may involve the exploitation unit 1400. In particular, the exploitation unit 1400 may provide one or more tools for that include a comprehensive set of proof-of-concept exploits, which may be in the form of one or more exploit templates for popular code components within a software supply chain, for creating one or more exploits that target and exploit the identified vulnerabilities within the software 121. The exploitation unit 1400 may further be involved in validating the created exploits by determining whether or not the vulnerabilities of the software 121 were successfully exploited by the generated exploits.

The sixth step for the method of software assessment may involve the remediation unit 1600 generating one or more remediation plans for the vulnerabilities of the software 121. The remediation unit 1600 may be further involved in validating the remediation plans by determining whether or not the remediation plans for the software 121 to successfully patch out the vulnerabilities within the software 121 for the software to become unaffected by previously afflicted exploits.

In particular, it is to be noted that any one or a combination of the units 200, 400, 600, 800, 1000, 1200, 1400, 1600 may be capable of generating reports that include qualitative information and quantitative information such as risk score, vulnerability assessments, exploit information, and suggested workarounds or mitigations.

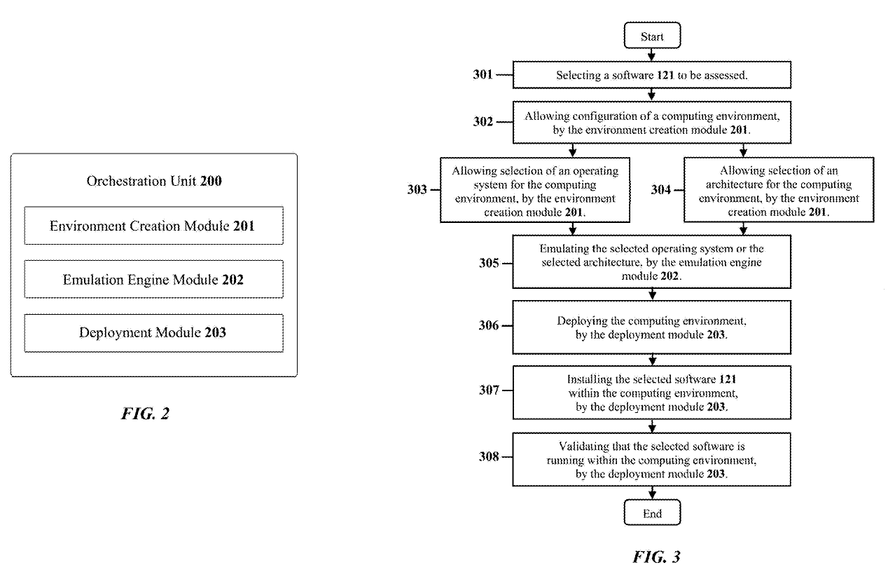

FIGS. 2-3 relate to the orchestration unit 200. More specifically, FIG. 2 illustrates the relevant modules of the orchestration unit 200. Whereas, FIG. 3 illustrates the steps that are performed by the orchestration unit 200 for orchestrating at least one live or emulated computing environment that is suitable for the software 121 to be assessed.

With reference to FIG. 2, the orchestration unit 200 may comprise one or more software modules that include an environment creation module 201, an emulation engine module 202, and a deployment module 203.

With reference to FIG. 3, the step of orchestrating the computing environment by the orchestration unit 200 may include one or more steps 301 – 308.

First there is step 301, which involves the user A selecting a software 121 to be assessed. More specifically, the user A may select one or more files that correspond to the software 121, such as its executable file (.exe), batch file (.bat), or the like.

Following step 301 is step 302. Step 302 involves allowing configuration of a computing environment, by the environment creation module 201. More specifically, the second device 12 may present the user A with a user interface in which the user A may be allowed to configure one or more computing environments therefrom. More specifically, the user A may be allowed to select of one or more operating systems, instruction set architectures, firmware architectures, or the like, that correspond to at least one computing environment that is to be live and/or emulated.

Following step 302 may be either one or both step 303 and step 304. More specifically, step 303 involves allowing the user A selection of at least one operating system for the computing environment, by the environment creation module 201. Whereas, step 304 involves allowing selection of at least one instruction set architecture and/or firmware architecture for the computing environment, by the environment creation module 201. It is to be noted that step 303 and step 304 may be carried out in a parallel manner or a sequential manner.

Following step 303 and step 304 may be step 305. Step 305 involves emulating the selected operating system, the selected instruction set architecture, and/or the selected firmware architecture, by the emulation engine module 202. In particular, depending on the implementation of the system, emulation of the computing environment may take place on the computing device 11, or at a separate computing device that is part of a cloud computing infrastructure. The resources required for the emulation of the computing environment may be derived from the computing device 11 or from other computing devices that may be part of a cloud computing infrastructure.

Following step 305 is step 306. Step 306 involves deploying the computing environment, by the deployment module 203. More specifically, any one or a combination of the selected operating system, the selected instruction set architecture, and/or the selected firmware architecture may be booted for the computing environment to be deployed thereon.

Following step 306 is step 307. Step 307 involves installing the software 121 within the computing environment, by the deployment module 203.

Following step 307 is step 308. Step 308 involves validating that the selected software 121 is capable of running within the computing environment, by the deployment module 203.

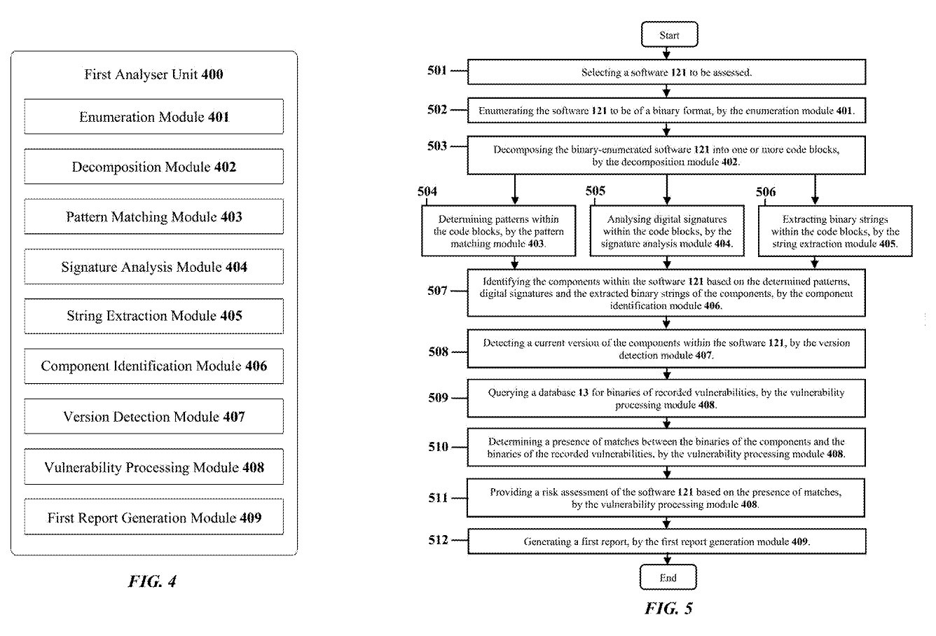

FIGS. 4-5 relate to the first analyser unit 400. In particular, FIG. 4 illustrates the relevant modules of the first analyser unit 400. Whereas, FIG. 5 illustrates the steps that are performed by the first analyser unit 400 for performing a first type of analysis on the software 121 that is under assessment, which may be a form of static analysis of the software 121.

With reference to FIG. 4, first analyser unit 400 may comprise one or more modules that include an enumeration module 401, a decomposition module 402, a pattern matching module 403, a signature analysis module 404, a string extraction module 405, a component identification module 406, a version detection module 407, a vulnerability processing module 408, and a first report generation module 409.

With reference to FIG. 5, the step of performing a first type of analysis upon the software 121 may include one or more steps 501 – 512. It is to be noted that the first type of analysis performed upon the software 121 generally does not require the software 121 to run within the computing environment.

In particular, first, there is a step 501, which involves the user A selecting a software 121 to be assessed. More specifically, the user A may select one or more files that correspond to the software 121 such as its executable file (.exe), batch file (.bat), or the like.

Following step 501 is step 502. Step 502 involves enumerating the software 121 into a binary format, by the enumeration module 401. In particular, the entirety of the software 121 may be translated into machine language that comprises ones and zeros, thereby generating a binary-enumerated software 121.

Following step 502 is step 503. Step 503 involves decomposing the binary-enumerated software 121 into one or more blocks of code, by the decomposition module 402.

Following step 503 may be either one or a combination of step 504, step 505, and step 506. In particular, these steps may be performed in a parallel manner or a sequential manner. In the event that steps 503 – 505 are executed in sequential manner, they may be carried out in any permissible order.

Step 504 may involve determining one or more patterns within the blocks of code, by the pattern matching module 403. More specifically, the pattern matching module 403 may detect patterns within the components, and may prompt the computing device 11 to communicate with the database 13 or the internet to match patterns within the blocks of code with patterns stored within code repositories of the database 13 and/or code repositories available on the internet.

Step 505 may involve analysing digital signatures that are within the blocks of code of the software 121, by the signature analysis module 404. In particular, the signature analysis module 404 may determine the presence of a digital signature within the software 121 based on its code components.

Step 506 may involve extracting one or more binary strings within the blocks of code, by the string extraction module 405. In particular, the string extraction module 405 is one that is configured to determine one or more significant sequences within these binaries.

Following step 504, step 505, and/or step 506 may be step 507. Step 507 involves identifying one or more code components within the software 121 based on the determined patterns, digital signatures and the extracted binary strings of the blocks of code, by the component identification module 406. In particular, the component identification module 406 may communicate with the database 13 or the internet to compile information therefrom for determining each and every code component that forms the software 121.

Following step 507 may be step 508, which involves detecting a current version of the code components within the software 121, by the version detection module 407. In particular, the versions of the code components may be determined by referencing code repositories stored in the database 13 and/or code repositories available on the internet.

Following step 508 is step 509. Step 509 involves querying the database 13 for determining binaries of known vulnerabilities that may be stored the database 13, by the vulnerability processing module 408.

Following step 509 is step 510. Step 510 involves determining a presence of matches between binaries of the code components and binaries of the known vulnerabilities as stored in the database 13, by the vulnerability processing module 408.

Following step 510 is step 511. Step 511 involves providing a risk assessment of the software 121 based on the presence of matches, by the vulnerability processing module 408.

Following step 511 is step 512. Step 512 involves generating a first report, by the first report generation module 409. The first report may include details such as an overall assessment of the vulnerabilities of the software 121, and it may be displayed on the second device 12.

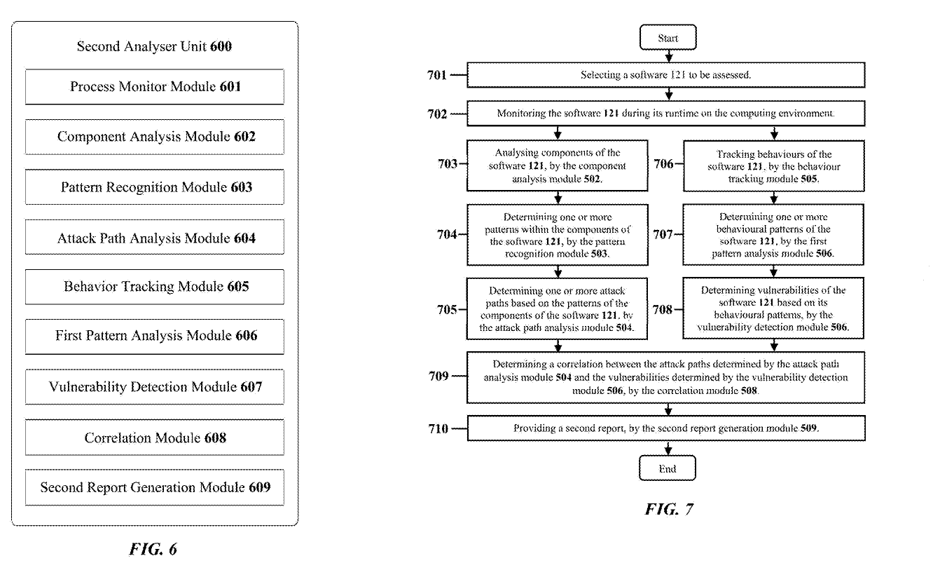

FIGS. 6-7 relate to the second analyser unit 600. In particular, FIG. 6 illustrates the relevant modules of the second analyser unit 600. Whereas, FIG. 7 illustrates the steps that are performed by the second analyser unit 600 for performing a first dynamic analysis on the software 121 that is under assessment.

With reference to FIG. 6, the second analyser unit 600 may comprise one or more modules that include a process monitor module 601, a component analysis module 602, a pattern recognition module 603, an attack path analysis module 604, a behaviour tracking module 605, a first pattern analysis module 606, a vulnerability detection module 607, a correlation module 608, and a second report generation module 609.

With reference to FIG. 7, the step of performing a first dynamic analysis upon the software 121 may include one or more steps 701 – 710. It is to be noted that the first dynamic analysis performed upon the software 121 requires the software 121 to run within the computing environment.

In particular, first, there is a step 701, which involves the user A selecting a software 121 to be assessed. More specifically, the user A may select one or more files that correspond to the software 121 such as its executable file (.exe), batch file (.bat), or the like.

Following step 701 is step 702, which involves monitoring the software 121 during its runtime within the computing environment.

Following step 702 are one or more set of steps. In particular, there may be a first set of steps, steps 703 – 705, and a second set of steps, steps 706 – 708. It is to be noted that the first set of steps and the second set of steps may be performed in a sequential manner or a parallel manner.

The first set of steps, steps 703 – 705, shall now be described. In particular, step 703 may follow from step 702. Step 703 involves analysing code components of the software 121, by the component analysis module 602. Following step 703 is step 704, which involves determining one or more patterns within the components of the software 121, by the pattern recognition module 603. Following step 704 is step 705, which involves determining one or more attack paths based on the patterns of the components of the software 121, by the attack path analysis module 604.

The second set of steps, steps 706 – 708, shall now be described. In particular, Step 706 may follow from step 702. Step 706 involves tracking behaviours of the software 121, by the behaviour tracking module 605. Following step 706 is step 707, which involves determining one or more behavioural patterns of the software 121, by the first pattern analysis module 606. Following step 707 is step 708, which involves determining vulnerabilities of the software 121 based on its behavioural patterns, by the vulnerability detection module 607.

Following steps 705 or step 708, is step 709. Step 709 involves determining a correlation between the attack paths as determined by the attack path analysis module 604, and the vulnerabilities as determined by the vulnerability detection module 607, by the correlation module 608.

Finally, following step 709 is step 710. Step 710 involves providing a second report, by the second report generation module 609. The second report may be a security report that includes details such as potential vulnerabilities found within the software 121 based on the first dynamic analysis, and it may be displayed on the second device 12.

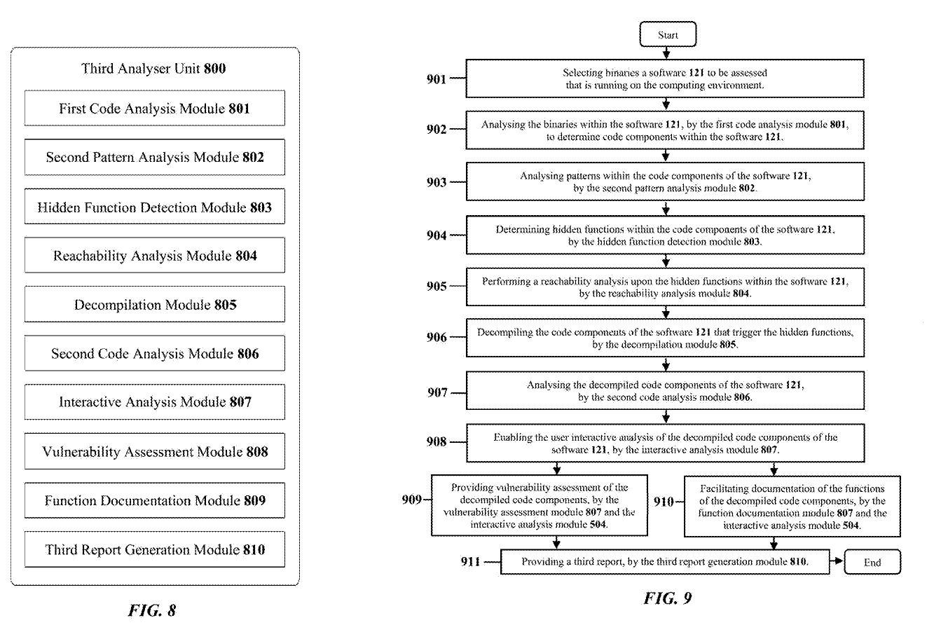

FIGS. 8-9 relate to the third analyser unit 800. In particular, FIG. 8 illustrates the relevant modules of the third analyser unit 800. Whereas, FIG. 9 illustrates the steps that are performed by the third analyser unit 800 for performing a second dynamic analysis on the software 121 that is under assessment.

With reference to FIG. 8, the third analyser unit 800 may comprise one or more modules that include a first code analysis module 801, a second pattern analysis module 802, a hidden function detection module 803, a reachability analysis module 804, a decompilation module 805, a second code analysis module 806, an interactive analysis module 807, a vulnerability assessment module 808, a function documentation module 809, and a third report generation module 810.

With reference to FIG. 9, the step of performing a second dynamic analysis upon the software 121 may include one or more steps 901 – 911. It is to be noted that the second dynamic analysis performed upon the software 121 requires the software 121 to run within the computing environment.

In particular, there is a first step, step 901. Step 901 involves selecting one or more binaries of the software 121, which is currently running on computing environment, for their assessment.

Following step 901 is step 902. Step 902 involves analysing the binaries within the software 121, by the first code analysis module 801, to determine code components within the software 121.

Following step 902 is step 903. Step 903 involves analysing patterns within the code components of the software 121, by the second pattern analysis module 802.

Following step 903 is step 904. Step 904 involves determining hidden functions within the code components of the software 121, by the hidden function detection module 803.

Following step 904 is step 905. Step 905 involves performing a reachability analysis upon the hidden functions within the software 121, by the reachability analysis module 804.

Following step 905 is step 906. Step 906 involves decompiling the code components of the software 121 that cause execution of the hidden functions, by the decompilation module 805.

Following step 906 is step 907. Step 907 involves analysing the decompiled code components of the software 121, by the second code analysis module 806.

Following step 907 is step 908. Step 908 involves enabling the interactive analysis of the decompiled code components of the software 121, by the interactive analysis module 807.

Following step 908 is either one or both step 909 and step 910. In particular, step 909 involves providing a vulnerability assessment of the decompiled code components, by the vulnerability assessment module 808 and the interactive analysis module 807. In particular, step 910 involves facilitating documentation of the functions of the decompiled code components, by the function documentation module 809 and the interactive analysis module 807.

Following step 909 or 910, is step 911. Step 911 involves providing a third report, by the third report generation module 810. The third report may be an analysis report that includes details such as potential vulnerabilities found within the software 121 based on the second dynamic analysis, and it may be displayed on the second device 12.

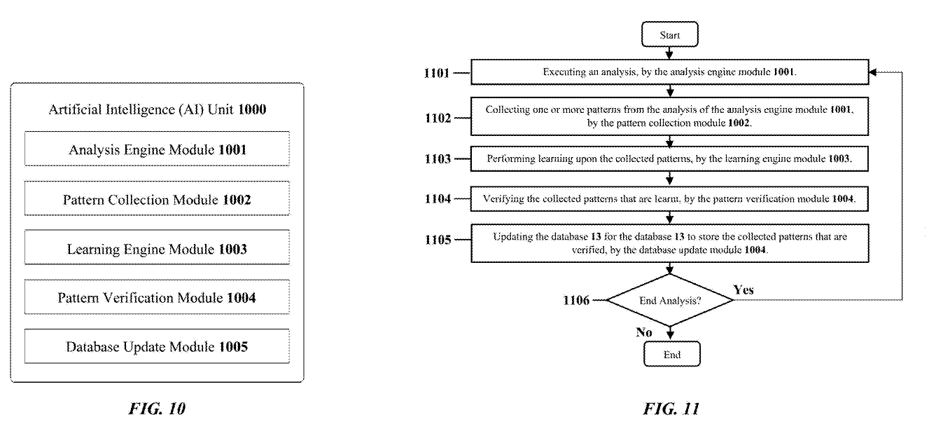

FIGS. 10-11 relate to the artificial intelligence (AI) unit 1000. In particular, FIG. 10 illustrates the relevant modules of the AI unit 1000. Whereas, FIG. 11 illustrates the steps that are performed by the AI unit 1000, specifically for learning one or more patterns for it to automatically assist or aid the other units and/or the user A in performing analysis upon the software 121.

With reference to FIG. 10, the artificial intelligence unit 1000 may comprise one or more modules that include an analysis engine module 1001, a pattern collection module 1002, a learning engine module 1003, a pattern verification module 1004, and a database update module 1005.

With reference to FIG. 11, the step of performing learning of one or more patterns by the artificial intelligence unit 1000 may include one or more steps 1101 – 1106. It is to be noted that the learning of patterns may or may not require the software 121 to run within the computing environment.

In particular, there is a first step, step 1101, which involves executing an analysis that may be upon code components or code blocks of the software 121 that is under assessment, by the analysis engine module 1001.

Following step 1101 may be step 1102, which involves collecting one or more patterns from the analysis of the analysis engine module 1001, by the pattern collection module 1002. By way of example, the patterns may be code components or code blocks of the software 121 that exhibit repetitions.

Following step 1102 is step 1103, which involves performing learning upon the collected patterns, by the learning engine module 1003. By way of example, the learning engine module 1003 may assign at least one machine learning model to be trained for the machine learning model to learn the patterns through adjustment of its weights and biases over a predetermined number of epochs.

Following step 1103 is step 1104, which involves verifying the collected patterns that are learnt, by the pattern verification module 1004. By way of example, the pattern verification module 1004 may validate the machine learning model that was trained, by determining whether or not it is capable of successfully identifying the learnt patterns.

Following step 1104 is step 1105, which involves updating the database 13 for the database 13 to store the collected patterns previously collected in step 1102. The database 13 may also be updated to store updated weights and biases of the machine learning model that was trained to learn the collected patterns.

Following step 1105 is step 1106. Step 1106 is a decision step that involves determining whether or not the analysis is to end. In the event where the analysis is to end, the artificial intelligence unit 1000 will stop its analysis. In the event that the analysis is to continue, step 1106 may loop back to step 1101 and repeat therefrom for a different machine learning model or a machine learning model of the same to be trained to learn one or more newly collected patterns.

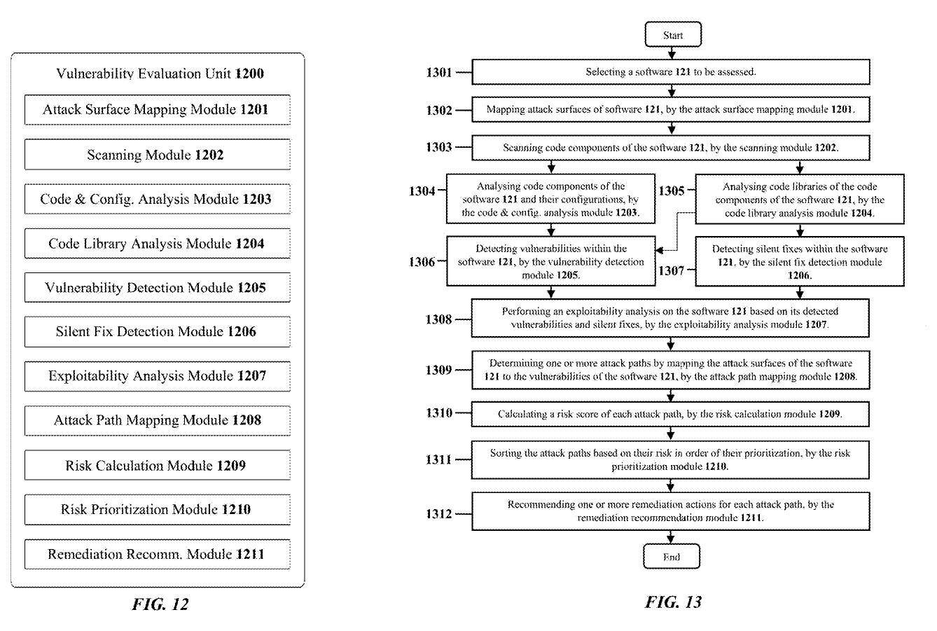

FIGS. 12-13 relate to the vulnerability evaluation unit 1200. In particular, FIG. 12 illustrates the relevant modules of the vulnerability evaluation unit 1200. Whereas, FIG. 13 illustrates the steps that are performed by the vulnerability evaluation unit 1200 for determining and evaluating vulnerabilities within the software 121.

With reference to FIG. 12, the vulnerability evaluation unit 1200 may comprise one or more modules that include an attack surface mapping module 1201, a scanning module 1202, a code and configuration analysis module 1203, a code library analysis module 1204, a vulnerability detection module 1205, a silent fix detection module 1206, an exploitability analysis module 1207, an attack path mapping module 1208, a risk calculation module 1209, a risk prioritization module 1210, and a remediation recommendation module 1211.

With reference to FIG. 13, the step of determining and evaluating vulnerabilities within the software 121, by the vulnerability evaluation unit 1200, may include one or more steps 1301 – 1312. It is to be noted that these steps may or may not require the software 121 to run within the computing environment.

In particular, there is a first step, step 1301, which involves selecting a software 121 to be assessed.

Following step 1301 may be step 1302, which involves mapping attack surfaces of software 121, by the attack surface mapping module 1201.

Following step 1302 may be step 1303, which involves scanning one or more code components within the software 121, by the scanning module 1202.

Following step 1303 may be either one or both step 1304 and step 1305. In particular, step 1304 may involve analysing code components of the software 121 and their configurations, by the code and configuration analysis module 1203. Whereas, step 1305 may involve analysing code libraries of the code components of the software 121, by the code library analysis module 1204. It is to be noted that step 1304 and step 1305 may be performed in a sequential manner or in a parallel manner.

Following either one or both step 1304 and step 1305 may be step 1306. Step 1306 involves detecting vulnerabilities within the software 121, by the vulnerability detection module 1205.

Following step 1305 may be step 1307, which involves detecting silent fixes within the software 121, by the silent fix detection module 1206.

Following either one or both step 1306 and step 1307 may be step 1308. Step 1308 may involve performing an exploitability analysis on the software 121 based on the vulnerabilities and silent fixes that were detected within the software 121, by the exploitability analysis module 1207.

Following step 1308 may be step 1309, which involves determining one or more attack paths by mapping the attack surfaces of the software 121 to the vulnerabilities of the software 121, by the attack path mapping module 1208.

Following step 1309 may be step 1310, which involves calculating a risk score for each attack path, by the risk calculation module 1209.

Following step 1310 may be step 1311, which involves sorting the attack paths based on their risk in order of their prioritization, by the risk prioritization module 1210.

Following step 1311 may be step 1312, which involves recommending one or more remediation actions for each attack path, by the remediation recommendation module 1211.

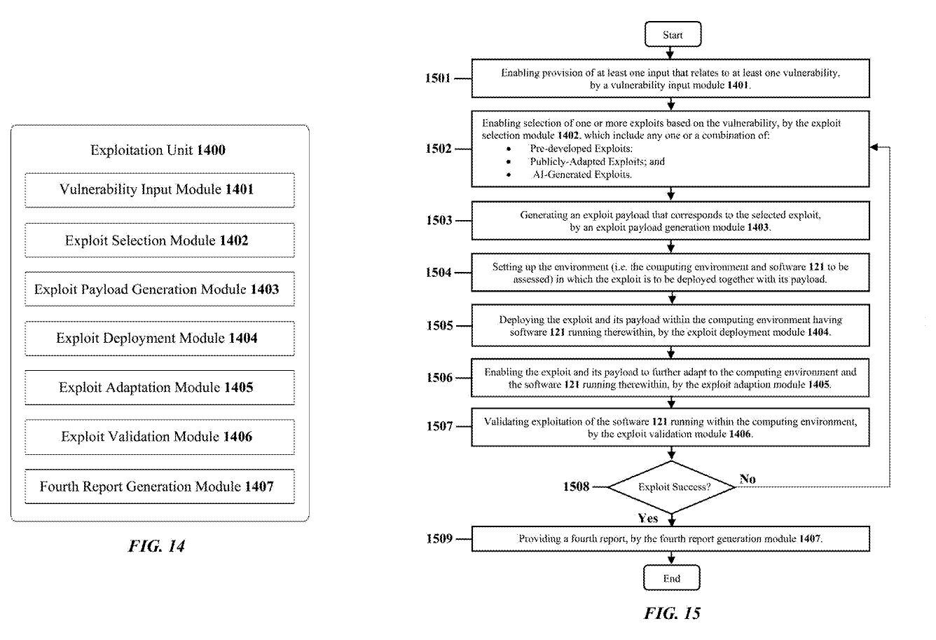

FIGS. 14-15 relate to the exploitation unit 1400. In particular, FIG. 14 illustrates the relevant modules of the exploitation unit 1400. Whereas, FIG. 15 illustrates the steps that are performed by the exploitation unit 1400 for generating and validating one or more exploits that target vulnerabilities within the software 121.

With reference to FIG. 14, the exploitation unit 1400 may comprise one or more software modules that include a vulnerability input module 1401, an exploit selection module 1402, an exploit payload generation module 1403, an exploit deployment module 1404, an exploit adaptation module 1405, an exploit validation module 1406, and a fourth report generation module 1407.

With reference to FIG. 15, the step of generating and validating one or more exploits that target vulnerabilities within the software 121, by the exploitation unit 1400, may include one or more steps 1501 – 1509. It is to be noted that these steps may or may not require the software 121 to run within the computing environment.

In particular, there is a first step, step 1501, which involves enabling provision of at least one input that relates to at least one vulnerability, by the vulnerability input module 1401.

Following step 1501 may be step 1502, which involves enabling selection of one or more exploits based on the vulnerability, by the exploit selection module 1402. The exploits that may be selected may include one or a combination of pre-developed exploits in the form of reusable templates, publicly-adapted exploits, and exploits generated through artificial intelligence (i.e., AI generated exploits).

Following step 1502 may be step 1503, which involves generating an exploit payload that corresponds to the selected exploit, by an exploit payload generation module 1403.

Following step 1503 may be step 1504, which involves setting up the computing environment for the software 121 to run therewithin.

Following step 1504 may be step 1505, which involves deploying the exploit and its payload within the computing environment having the software 121 running therewithin, by the exploit deployment module 1404.

Following step 1505 may be step 1506, which involves enabling the exploit and its payload to further adapt to the computing environment and the software 121 operating therewithin, by the exploit adaptation module 1405.

Following step 1506 may be step 1507, which involves validating exploitation of the software 121 operating within the computing environment, by the exploit validation module 1406.

Following step 1507 may be step 1508, which may be a decision step that involves determining whether or not the vulnerabilities of the software 121 were successfully exploited by the generated exploits. In the event that the exploitation of the software 121 was successful, step 1508 may proceed to step 1509. Else, step 1508 may loop back to step 1502 and repeat therefrom.

Step 1509 involves generating a fourth report, by the fourth report generation module 1407. The fourth report may be a validation report that includes details such as validation of the generated exploits, and it may be displayed on the second device 12.

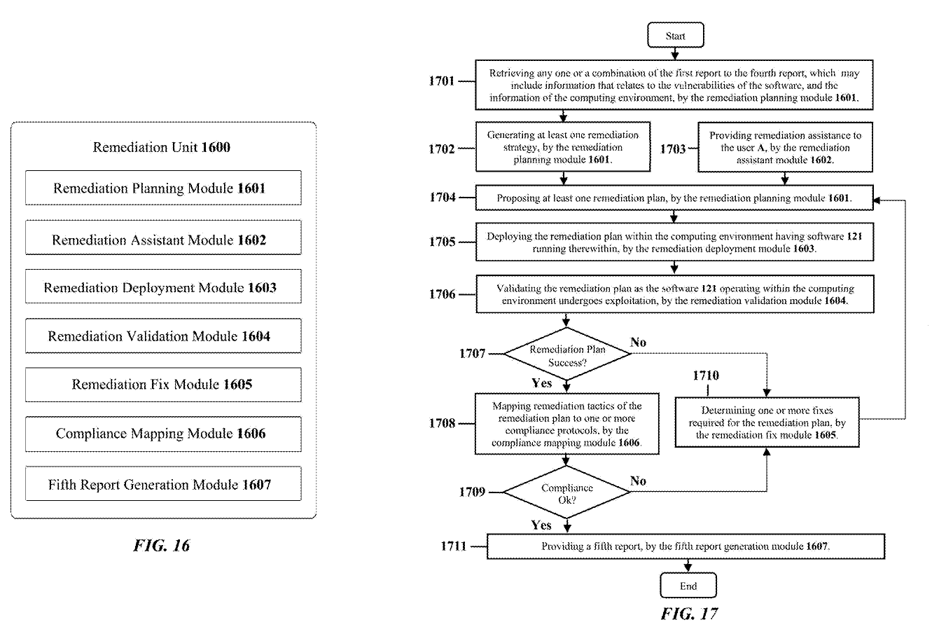

FIGS. 16-17 relate to the remediation unit 1600. In particular, FIG. 16 illustrates the relevant modules of the remediation unit 1600. Whereas, FIG. 17 illustrates the steps that are performed by the remediation unit 1600 for remediating vulnerabilities within the software 121.

With reference to FIG. 16, the remediation unit 1600 may comprise one or more modules that include a remediation planning module 1601, a remediation assistant module 1602, a remediation deployment module 1603, a remediation validation module 1604, a remediation fix module 1605, a compliance mapping module 1606, and a fifth report generation module 1607.

With reference to FIG. 17, the step of remediating vulnerabilities within the software 121, by the remediation unit 1600, may include one or more steps 1701 – 1711. It is to be noted that these steps may or may not require the software 121 to run within the computing environment.

In particular, there is a first step, step 1701, which involves retrieving any one or a combination of the first report to the fourth report, which may include information that relates to the vulnerabilities of the software, and the information of the computing environment, by the remediation planning module 1601.

Following step 1701 may be either one or both step 1702 and step 1703. In particular, step 1702 involves generating at least one remediation strategy, by the remediation planning module 1601. Whereas, step 1703 involves providing remediation assistance or aid to the user, by the remediation assistant module 1602.

Following any one or both step 1702 or step 1703 may be step 1704, which involves proposing at least one remediation plan, by the remediation planning module 1601.

Following step 1704 may be step 1705, which involves deploying the remediation plan within the computing environment that has the software 121 running therewithin, by the remediation deployment module 1603. More specifically, the remediation deployment module 1603 may patch out one or more vulnerabilities within the software 121 that may be previously detected by the vulnerability evaluation unit 1200.

Following step 1705 may be step 1706, which involves validating the remediation plan as the software 121 runs within the computing environment, by the remediation validation module 1604. More specifically, the remediation validation module 1604 is involved in communicating with the exploitation unit 1400, for deploying one or more exploits that target one or more vulnerabilities that were previously detected within the software 121.

Following step 1706 may be step 1707, which is a decision step whereby it is determined that whether or not the remediation plan was a success. More specifically, a remediation plan may be deemed successful when the software 121, which was patched based on the remediation plan, was resilient to the exploits deployed against it. In the event that the remediation plan was a success, step 1707 may proceed to step 1708. Else, in the event that the remediation plan was a failure, step 1707 may proceed to step 1710.

In step 1708, since it was determined that the remediation plan was a success, step 1708 is performed, which involves mapping one or more remediation tactics of the remediation plan to one or more compliance protocols, by the compliance mapping module 1606. In particular, the compliance protocols may be a set of protocols in which the software 121 is to abide to. This step is performed to ensure that the patches done upon the software 121 through the remediation plan does not cause unintentional change in the operational and/or functional behaviour of the software 121.

Following step 1708 may be step 1709, which is a decision step whereby it is determined that whether or not the patched software 121 is in compliance with the compliances protocol. In the event that the all remediation tactics of the remediation plan are mappable to the compliance protocols, then the software 121 is regarded as compliant, and step 1709 may proceed to step 1711. Else, in the event that that not all remediation tactics of the remediation plan mappable, then the software 121 is regarded as non-compliant, and step 1709 may proceed to step 1710.

Step 1710 may be a step that follows from either step 1707 or step 1709. At this point, the patched software 121 may either have remaining vulnerabilities that are capable of being exploited, or may not behave according to the compliance protocols due to the patches. As such, step 1710 may involve determining one or more fixes required for the remediation plan, by the remediation fix module 1605. After one or more fixes are determined, step 1710 may loop back to step 1704 for a new remediation plan to be proposed based on these fixes, and subsequently continue therefrom.

Following step 1709 may be step 1711, which involves providing a fifth report, by the fifth report generation module 1607. The fifth report may be a report that includes details such as validation of the generated remediation plan, and it may be displayed on the second device 12.

With this, a system and a corresponding method for software assessment have been presented and described. The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the disclosure.

The present invention has industrial applicability in the field of cybersecurity, software development, and information technology. In particular, the system and method for software assessment may be applicable to organizations that develop, deploy, or maintain software systems and have a need to assess and remediate security vulnerabilities within their software. The present invention may also be applicable to security service providers, software auditing firms, and enterprises seeking to enhance the security posture of their software products and infrastructure.

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1: A system for automated security assessment of software across heterogeneous computing environments, comprising: at least one processor configured to operate: an orchestration unit configured to emulate at least one operating system and at least one instruction set architecture to provide a computing environment, deploy the software within the computing environment, and validate that the software is capable of running within the computing environment; one or more analyser units configured to analyse the software as the software runs within the computing environment to determine one or more vulnerabilities within the software; and an exploitation unit configured to generate one or more exploits targeting the determined vulnerabilities, deploy the exploits against the software within the computing environment, and adjust one or more parameters of the exploits based on the operating system and the instruction set architecture of the computing environment in which the software is running.

Clause 2: Clause 1, wherein the orchestration unit is further configured to emulate at least one firmware architecture including a Unified Extensible Firmware Interface or a Basic Input/Output System.

Clause 3: Any of Clauses 1-2, wherein the operating system includes any one or a combination of the Windows operating system, the Unix operating system, Unix-like operating systems including MacOS, the Linux operating system, the QNX operating system, FreeBSD, or WindowsCE.

Clause 4: Any of Clauses 1-3, wherein the instruction set architecture includes any one or a combination of x86 with 16-bit extension, x86 with 32-bit extension, x86 with 64-bit extension, ARM with 64-bit extension, MIPS, PowerPC, RISC-V, or Atmel AVR.

Clause 5: Any of Clauses 1-4, wherein the orchestration unit is further configured to: allow configuration of the computing environment including selection of the operating system and the instruction set architecture; deploy the computing environment; install the software within the computing environment; and validate that the software is capable of running within the computing environment.

Clause 6: Any of Clauses 1-5, wherein the exploitation unit is further configured to perform offset calculations for the exploits to adapt to different versions of the operating system of the computing environment.

Clause 7: Any of Clauses 1-6, wherein the exploitation unit is further configured to: generate the exploits based on one or more templates, wherein the templates include pre-developed exploits for vulnerable libraries of various versions; deploy the exploits against the software within the computing environment; and validate successful exploitation of the vulnerabilities of the software by the exploits.

Clause 8: Clause 7, wherein the exploitation unit is further configured to modify publicly available exploits for them to adapt to the computing environment emulated by the orchestration unit.

Clause 9: Any of Clauses 1-8, wherein the instructions further cause the processor to operate a remediation unit configured to: generate and deploy at least one remediation plan having one or more tactics for remedying the vulnerabilities of the software, for the software to become a patched software; validate the remediation plan by deploying exploits that target the vulnerabilities against the patched software; and map the tactics of the remediation plan to one or more compliance protocols to ensure the patched software remains compliant with the compliance protocols.

Clause 10: Any of Clauses 1-9, wherein the instructions further cause the processor to operate an artificial intelligence unit configured to: execute an analysis upon code components of the software; collect one or more patterns from the analysis; perform learning upon the collected patterns by training at least one machine learning model; and update a database to store the collected patterns and updated weights and biases of the machine learning model.

Clause 11: Clause 10, wherein the artificial intelligence unit is further configured to enable automated generation of exploits that target the vulnerabilities within the software based on the computing environment emulated by the orchestration unit.

Clause 12: A method for automated security assessment of software across heterogeneous computing environments, comprising: emulating, by an orchestration unit operated by at least one processor, at least one operating system and at least one instruction set architecture to provide a computing environment; deploying, by the orchestration unit, the software within the computing environment; validating, by the orchestration unit, that the software is capable of running within the computing environment; analysing, by one or more analyser units operated by the processor, the software as the software runs within the computing environment to determine one or more vulnerabilities within the software; generating, by an exploitation unit operated by the processor, one or more exploits targeting the determined vulnerabilities; deploying, by the exploitation unit, the exploits against the software within the computing environment; and adjusting, by the exploitation unit, one or more parameters of the exploits based on the operating system and the instruction set architecture of the computing environment in which the software is running.

Clause 13: Clause 12, further comprising emulating, by the orchestration unit, at least one firmware architecture including a Unified Extensible Firmware Interface or a Basic Input/Output System.

Clause 14: Any of Clauses 12-13, wherein the operating system includes any one or a combination of the Windows operating system, the Unix operating system, Unix-like operating systems including MacOS, the Linux operating system, the QNX operating system, FreeBSD, or WindowsCE.

Clause 15: Any of Clauses 12-14, wherein the instruction set architecture includes any one or a combination of x86 with 16-bit extension, x86 with 32-bit extension, x86 with 64-bit extension, ARM with 64-bit extension, MIPS, PowerPC, RISC-V, or Atmel AVR.

Clause 16: Any of Clauses 12-15, further comprising: allowing, by the orchestration unit, configuration of the computing environment including selection of the operating system and the instruction set architecture; deploying, by the orchestration unit, the computing environment; installing, by the orchestration unit, the software within the computing environment; and validating, by the orchestration unit, that the software is capable of running within the computing environment.

Clause 17: Any of Clauses 12-16, further comprising performing, by the exploitation unit, offset calculations for the exploits to adapt to different versions of the operating system of the computing environment.

Clause 18: Any of Clauses 12-17, further comprising: generating, by the exploitation unit, the exploits based on one or more templates, wherein the templates include pre-developed exploits for vulnerable libraries of various versions; deploying, by the exploitation unit, the exploits against the software within the computing environment; and validating, by the exploitation unit, successful exploitation of the vulnerabilities of the software by the exploits.

Clause 19: Any of Clauses 12-18, further comprising: generating and deploying, by a remediation unit operated by the processor, at least one remediation plan having one or more tactics for remedying the vulnerabilities of the software, for the software to become a patched software; validating, by the remediation unit, the remediation plan by deploying exploits that target the vulnerabilities against the patched software; and mapping, by the remediation unit, the tactics of the remediation plan to one or more compliance protocols to ensure the patched software remains compliant with the compliance protocols.

Clause 20: Any of Clauses 12-19, further comprising: executing, by an artificial intelligence unit operated by the processor, an analysis upon code components of the software; collecting, by the artificial intelligence unit, one or more patterns from the analysis; performing, by the artificial intelligence unit, learning upon the collected patterns by training at least one machine learning model; and updating, by the artificial intelligence unit, a database to store the collected patterns and updated weights and biases of the machine learning model.

Clause 21: One or more non-transitory computer-readable media storing instructions thereon that, when executed by at least one processor, cause the at least one processor to perform operations comprising: emulating at least one operating system and at least one instruction set architecture to provide a computing environment; deploying software within the computing environment; validating that the software is capable of running within the computing environment; analysing the software as the software runs within the computing environment to determine one or more vulnerabilities within the software; generating one or more exploits targeting the determined vulnerabilities; deploying the exploits against the software within the computing environment; and adjusting one or more parameters of the exploits based on the operating system and the instruction set architecture of the computing environment in which the software is running.

Clause 22: Clause 21, wherein the operations further comprise emulating at least one firmware architecture including a Unified Extensible Firmware Interface or a Basic Input/Output System.

Clause 23: Any of Clauses 21-22, wherein the operating system includes any one or a combination of the Windows operating system, the Unix operating system, Unix-like operating systems including MacOS, the Linux operating system, the QNX operating system, FreeBSD, or WindowsCE.

Clause 24: Any of Clauses 21-23, wherein the instruction set architecture includes any one or a combination of x86 with 16-bit extension, x86 with 32-bit extension, x86 with 64-bit extension, ARM with 64-bit extension, MIPS, PowerPC, RISC-V, or Atmel AVR.

Clause 25: Any of Clauses 21-24, wherein the operations further comprise: allowing configuration of the computing environment including selection of the operating system and the instruction set architecture; deploying the computing environment; installing the software within the computing environment; and validating that the software is capable of running within the computing environment.

Clause 26: Any of Clauses 21-25, wherein the operations further comprise performing offset calculations for the exploits to adapt to different versions of the operating system of the computing environment.

Clause 27: Any of Clauses 21-26, wherein the operations further comprise: generating the exploits based on one or more templates, wherein the templates include pre-developed exploits for vulnerable libraries of various versions; deploying the exploits against the software within the computing environment; and validating successful exploitation of the vulnerabilities of the software by the exploits.

Clause 28: Clause 27, wherein the operations further comprise modifying publicly available exploits for them to adapt to the computing environment.

Clause 29: Any of Clauses 21-28, wherein the operations further comprise: generating and deploying at least one remediation plan having one or more tactics for remedying the vulnerabilities of the software, for the software to become a patched software; validating the remediation plan by deploying exploits that target the vulnerabilities against the patched software; and mapping the tactics of the remediation plan to one or more compliance protocols to ensure the patched software remains compliant with the compliance protocols.

Clause 30: Any of Clauses 21-29, wherein the operations further comprise: executing an analysis upon code components of the software; collecting one or more patterns from the analysis; performing learning upon the collected patterns by training at least one machine learning model; and updating a database to store the collected patterns and updated weights and biases of the machine learning model.

Clause 31: Clause 30, wherein the operations further comprise enabling automated generation of exploits that target the vulnerabilities within the software based on the computing environment.

Clause 32: Any of Clauses 1-11 and 21-31, wherein the one or more analyser units comprise a first analyser unit configured to decompose the software into one or more code components for their identification, and match each code component with binaries that correspond to known vulnerabilities to provide a risk assessment of the software based on the presence of matches.

Clause 33: Any of Clauses 1-11 and 21-32, wherein the one or more analyser units comprise a second analyser unit configured to determine one or more attack paths based on one or more code components of the software, determine one or more behavioural patterns of the software as the software runs within the computing environment, and determine at least one correlation between the attack paths and behavioural patterns.

Clause 34: Any of Clauses 1-11 and 21-33, wherein the one or more analyser units comprise a third analyser unit configured to determine one or more hidden functions within the software that arise as the software runs within the computing environment, and decompile one or more code components that trigger the hidden functions for their analysis.

Clause 35: Any of Clauses 1-11 and 21-34, wherein the instructions further cause the processor to operate a vulnerability evaluation unit configured to analyse one or more code components of the software for detecting vulnerabilities and silent fixes within the software, determine one or more attack paths within the software based on the detected vulnerabilities and silent fixes, provide a risk score for each attack path, and sort the attack paths based on their risk scores for their prioritization.

Clause 36: Any of Clauses 12-20, further comprising: decomposing, by a first analyser unit, the software into one or more code components for their identification; and matching, by the first analyser unit, each code component with binaries that correspond to known vulnerabilities to provide a risk assessment of the software based on the presence of matches.

Clause 37: Any of Clauses 12-20, further comprising: determining, by a second analyser unit, one or more attack paths based on one or more code components of the software; determining, by the second analyser unit, one or more behavioural patterns of the software as the software runs within the computing environment; and determining, by the second analyser unit, at least one correlation between the attack paths and behavioural patterns.

Clause 38: Any of Clauses 12-20, further comprising: determining, by a third analyser unit, one or more hidden functions within the software that arise as the software runs within the computing environment; and decompiling, by the third analyser unit, one or more code components that trigger the hidden functions for their analysis.

Clause 39: Any of Clauses 12-20, further comprising: analysing, by a vulnerability evaluation unit, one or more code components of the software for detecting vulnerabilities and silent fixes within the software; determining, by the vulnerability evaluation unit, one or more attack paths within the software based on the detected vulnerabilities and silent fixes; providing, by the vulnerability evaluation unit, a risk score for each attack path; and sorting, by the vulnerability evaluation unit, the attack paths based on their risk scores for their prioritization.

Clause 40: Any of Clauses 1-11 and 21-35, wherein the software includes one or more open source code components, one or more closed source code components, or a combination thereof.

Clause 41: Any of Clauses 12-20 and 36-39, wherein the software includes one or more open source code components, one or more closed source code components, or a combination thereof.

Clause 42: Any of Clauses 1-11 and 21-35, wherein the orchestration unit is configured to orchestrate the computing environment over one or more virtual machines.

Clause 43: Any of Clauses 12-20 and 36-39, wherein the computing environment is orchestrated over one or more virtual machines.

Clause 44: Any of Clauses 1-11 and 21-35, wherein the one or more analyser units are configured to perform static analysis to detect libraries and dependencies of code components within the software.

Clause 45: Any of Clauses 12-20 and 36-39, further comprising performing, by the one or more analyser units, static analysis to detect libraries and dependencies of code components within the software.

Clause 46: Any of Clauses 1-11 and 21-35, wherein the one or more analyser units are configured to perform dynamic analysis upon the software running on the computing environment to identify components, vulnerabilities, and behaviours that occur during runtime of the software.

Clause 47: Any of Clauses 12-20 and 36-39, further comprising performing, by the one or more analyser units, dynamic analysis upon the software running on the computing environment to identify components, vulnerabilities, and behaviours that occur during runtime of the software.

Clause 48: Any of Clauses 9 and 19 and 29, wherein the remediation unit is further configured to provide an interactive chatbot that offers real-time guidance, configuration recommendations, and step-by-step remediation instructions for the software based on the computing environment.

Clause 49: Any of Clauses 10-11 and 20 and 30-31, wherein the artificial intelligence unit is further configured to perform code matching, pattern recognition, and attack path analysis to reduce false positives and enhance accuracy of detected vulnerabilities within the software.

Clause 50: Any of Clauses 10-11 and 20 and 30-31, wherein the artificial intelligence unit is further configured to provide an interactive chatbot that assists a user in studying code components, their libraries, and their dependencies within the software to identify potential vulnerabilities.

Clause 51: Any of Clauses 1-11 and 21-35, wherein the system is deployed on a cloud computing infrastructure for scalable and automated analysis of the software.

Clause 52: Any of Clauses 1-11 and 21-35, wherein the system is deployed on a local computing infrastructure.

Clause 53: Any of Clauses 1-11 and 21-35, wherein the system is deployed on a hybrid architecture comprising both cloud computing infrastructure and local computing infrastructure.

Clause 54: Any of Clauses 1-11 and 21-35, wherein the software comprises firmware for IoT devices, OT devices, or embedded systems.

Clause 55: Any of Clauses 12-20 and 36-39, wherein the software comprises firmware for IoT devices, OT devices, or embedded systems.

Clause 56: Any of Clauses 1-11 and 21-35, wherein the software comprises a mobile application.

Clause 57: Any of Clauses 12-20 and 36-39, wherein the software comprises a mobile application.

Clause 58: Any of Clauses 1-11 and 21-35, wherein the vulnerability evaluation unit is further configured to determine undocumented fixes within the software by analysing code changes within corresponding code repositories.

Clause 59: Any of Clauses 12-20 and 36-39, further comprising determining, by a vulnerability evaluation unit, undocumented fixes within the software by analysing code changes within corresponding code repositories.

Clause 60: Any of Clauses 1-11 and 21-35, wherein the vulnerability evaluation unit is further configured to provide risk prioritization by calculating risk scores based on Common Vulnerability Scoring System metrics, exploit availability, and contextual information within the computing environment.

Clause 61: Any of Clauses 12-20 and 36-39, further comprising providing, by a vulnerability evaluation unit, risk prioritization by calculating risk scores based on Common Vulnerability Scoring System metrics, exploit availability, and contextual information within the computing environment.

Clause 62: Any of Clauses 1-11 and 21-35, wherein any one or a combination of the units is capable of generating reports that include risk score, vulnerability assessments, exploit information, and suggested workarounds or mitigations.

Clause 63: Any of Clauses 12-20 and 36-39, further comprising generating, by any one or a combination of the units, reports that include risk score, vulnerability assessments, exploit information, and suggested workarounds or mitigations.

1. A system for automated security assessment of software across heterogeneous computing environments, comprising:
an orchestration unit configured to emulate at least one operating system and at least one instruction set architecture to provide a computing environment, deploy the software within the computing environment, and validate that the software is capable of running within the computing environment;
one or more analyser units configured to analyse the software as the software runs within the computing environment to determine one or more vulnerabilities within the software; and
an exploitation unit configured to generate one or more exploits targeting the determined vulnerabilities, deploy the exploits against the software within the computing environment, and adjust one or more parameters of the exploits based on the operating system and the instruction set architecture of the computing environment in which the software is running.

2. The system of claim 1, wherein the orchestration unit is further configured to emulate at least one firmware architecture including a Unified Extensible Firmware Interface or a Basic Input/Output System.

3. The system of claim 1, wherein the operating system includes any one or a combination of the Windows operating system, the Unix operating system, Unix-like operating systems including MacOS, the Linux operating system, the QNX operating system, FreeBSD, or WindowsCE.

4. The system of claim 1, wherein the instruction set architecture includes any one or a combination of x86 with 16-bit extension, x86 with 32-bit extension, x86 with 64-bit extension, ARM with 64-bit extension, MIPS, PowerPC, RISC-V, or Atmel AVR.

5. The system of claim 1, wherein the orchestration unit is further configured to:
allow configuration of the computing environment including selection of the operating system and the instruction set architecture;
deploy the computing environment;
install the software within the computing environment; and
validate that the software is capable of running within the computing environment.

6. The system of claim 1, wherein the exploitation unit is further configured to perform offset calculations for the exploits to adapt to different versions of the operating system of the computing environment.

7. The system of claim 1, wherein the exploitation unit is further configured to:
generate the exploits based on one or more templates, wherein the templates include pre-developed exploits for vulnerable libraries of various versions;
deploy the exploits against the software within the computing environment; and
validate successful exploitation of the vulnerabilities of the software by the exploits.

8. The system of claim 7, wherein the exploitation unit is further configured to modify publicly available exploits for them to adapt to the computing environment emulated by the orchestration unit.

9. The system of claim 1, further comprising a remediation unit configured to:
generate and deploy at least one remediation plan having one or more tactics for remedying the vulnerabilities of the software, for the software to become a patched software;
validate the remediation plan by deploying exploits that target the vulnerabilities against the patched software; and
map the tactics of the remediation plan to one or more compliance protocols to ensure the patched software remains compliant with the compliance protocols.

10. The system of claim 1, further comprising an artificial intelligence unit configured to:
execute an analysis upon code components of the software;
collect one or more patterns from the analysis;
perform learning upon the collected patterns by training at least one machine learning model; and
update a database to store the collected patterns and updated weights and biases of the machine learning model.

11. The system of claim 10, wherein the artificial intelligence unit is further configured to enable automated generation of exploits that target the vulnerabilities within the software based on the computing environment emulated by the orchestration unit.

12. A method for automated security assessment of software across heterogeneous computing environments, comprising:
emulating, by an orchestration unit operated by at least one processor, at least one operating system and at least one instruction set architecture to provide a computing environment;
deploying, by the orchestration unit, the software within the computing environment;
validating, by the orchestration unit, that the software is capable of running within the computing environment;
analysing, by one or more analyser units operated by the processor, the software as the software runs within the computing environment to determine one or more vulnerabilities within the software;
generating, by an exploitation unit operated by the processor, one or more exploits targeting the determined vulnerabilities;
deploying, by the exploitation unit, the exploits against the software within the computing environment; and
adjusting, by the exploitation unit, one or more parameters of the exploits based on the operating system and the instruction set architecture of the computing environment in which the software is running.

13. The method of claim 12, further comprising emulating, by the orchestration unit, at least one firmware architecture including a Unified Extensible Firmware Interface or a Basic Input/Output System.

14. The method of claim 12, wherein the operating system includes any one or a combination of the Windows operating system, the Unix operating system, Unix-like operating systems including MacOS, the Linux operating system, the QNX operating system, FreeBSD, or WindowsCE.

15. The method of claim 12, wherein the instruction set architecture includes any one or a combination of x86 with 16-bit extension, x86 with 32-bit extension, x86 with 64-bit extension, ARM with 64-bit extension, MIPS, PowerPC, RISC-V, or Atmel AVR.

16. The method of claim 12, further comprising:
allowing, by the orchestration unit, configuration of the computing environment including selection of the operating system and the instruction set architecture;
deploying, by the orchestration unit, the computing environment;
installing, by the orchestration unit, the software within the computing environment; and
validating, by the orchestration unit, that the software is capable of running within the computing environment.

17. The method of claim 12, further comprising performing, by the exploitation unit, offset calculations for the exploits to adapt to different versions of the operating system of the computing environment.

18. The method of claim 12, further comprising:
generating, by the exploitation unit, the exploits based on one or more templates, wherein the templates include pre-developed exploits for vulnerable libraries of various versions;
deploying, by the exploitation unit, the exploits against the software within the computing environment; and
validating, by the exploitation unit, successful exploitation of the vulnerabilities of the software by the exploits.

19. The method of claim 12, further comprising:
generating and deploying, by a remediation unit operated by the processor, at least one remediation plan having one or more tactics for remedying the vulnerabilities of the software, for the software to become a patched software;
validating, by the remediation unit, the remediation plan by deploying exploits that target the vulnerabilities against the patched software; and
mapping, by the remediation unit, the tactics of the remediation plan to one or more compliance protocols to ensure the patched software remains compliant with the compliance protocols.

20. The method of claim 12, further comprising:
executing, by an artificial intelligence unit operated by the processor, an analysis upon code components of the software;
collecting, by the artificial intelligence unit, one or more patterns from the analysis;
performing, by the artificial intelligence unit, learning upon the collected patterns by training at least one machine learning model; and
updating, by the artificial intelligence unit, a database to store the collected patterns and updated weights and biases of the machine learning model.
